(19) United States
(12) Patent Application Publication
(10) Pub. No.: US 2025/0063965 A1
(43) Pub. Date: Feb. 27, 2025

(54) STRIP TILLAGE IMPLEMENT WITH A ROLL LOCK ASSEMBLY

(71) Applicant: CNH Industrial America LLC, New Holland, PA (US)

(72) Inventors: Austin Joseph Lewandowski, Congerville, IL (US); Brian Michael Craig, Congerville, IL (US)

(21) Appl. No.: 18/808,865

(22) Filed: Aug. 19, 2024

Related U.S. Application Data
(60) Provisional application No. 63/578,397, filed on Aug. 24, 2023.

(51) Int. Cl. A01B 23/04; A01B 59/043

(52) U.S. Cl. CPC A01B 23/04; A01B 59/043

(57) ABSTRACT

A strip tillage implement includes a toolbar frame and a hitch frame rotatably coupled together. Additionally, the implement includes a roll lock assembly alterable between a locked and unlocked configuration. The roll lock assembly includes a locking bar rotatably coupled to the toolbar frame. Furthermore, the roll lock assembly includes a locking fastener configured to be selectively installed relative to the locking bar and the hitch frame. When the roll lock assembly is in the locked configuration, the locking fastener is inserted through both the hitch frame and the locking bar to couple the locking bar to the hitch frame in a manner that limits relative rotation of the toolbar frame and the hitch frame. Additionally, when the roll lock assembly is in the unlocked configuration, the locking bar is movable relative to the portion of the hitch frame with relative rotation between the toolbar frame and the hitch frame.

### CROSS-REFERENCE TO RELATED APPLICATIONS

This application is based upon and claims the right of priority to U.S. Provisional Patent Application No. 63/578,397, filed on Aug. 24, 2023, the disclosure of which is hereby incorporated by reference herein in its entirety for all purposes.

### FIELD OF THE INVENTION

The present subject matter relates generally to agricultural implements, such as strip tillage implements and, more particularly, to a strip tillage implement with a roll lock assembly.

### BACKGROUND OF THE INVENTION

It is well known that, to attain the best agricultural performance from a field, a farmer must cultivate the soil, such as through a tillage operation. Tillage implements typically include one or more ground engaging tools configured to engage the soil as the implement is moved across the field. Such ground engaging tool(s) loosen and/or otherwise agitate the soil to prepare the field for subsequent agricultural operations, such as planting operations. Strip tillage implements, unlike traditional tillage implements, include row units having one or more of such ground-engaging tools, where the row units only work narrow strips of the field in which subsequent operations (e.g., planting) will occur, instead of working the entire field along the swath of the implement. Such row units may be supported by a toolbar frame, which may be coupled to a hitch frame coupling the strip tillage implement to an agricultural vehicle, such as a tractor. During the performance of a strip tillage operation, relative motion between the toolbar frame and hitch frame is typically desirable to allow the implement to follow the counter of the field. However, during transport of the implement, such relative motion between the toolbar frame and hitch frame is undesirable.

Accordingly, a strip tillage implement with an improved roll lock assembly would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a strip tillage implement. The strip tillage implement includes a toolbar frame and a plurality of row units supported by the toolbar frame. The strip tillage implement also includes a plurality of ground-engaging tools supported by each row unit of the plurality of row units and configured to engage a field surface. Additionally, the strip tillage implement includes a hitch frame configured to couple the strip tillage implement to a tow vehicle. The hitch frame is coupled to the toolbar frame at a first pivot joint, and the hitch frame and the toolbar frame are configured to rotate relative to each other about the first pivot joint. Furthermore, the strip tillage implement includes a roll lock assembly alterable between a locked configuration and an unlocked configuration. The roll lock assembly includes a locking bar extending between a first end a second end and coupled to the toolbar frame at a second pivot joint such that the locking bar is configured to rotate relative to the toolbar frame about the second pivot joint. Additionally, the roll lock assembly includes a locking fastener configured to be selectively installed relative to the locking bar and the hitch frame. Furthermore, when the roll lock assembly is in the locked configuration, the locking fastener is inserted through both a portion of the hitch frame and a portion of the locking bar to couple the locking bar to the hitch frame in a manner that limits rotation of the toolbar frame and the hitch frame relative to each other. Moreover, when the roll lock assembly is in the unlocked configuration, the locking bar is movable relative to the portion of the hitch frame with relative rotation between the toolbar frame and the hitch frame.

In another aspect, the present subject matter is directed to an agricultural implement. The agricultural implement includes a first frame member and a second frame member coupled to the first frame member at a first pivot joint. The second frame member and the first frame member are configured to rotate relative to each other about the first pivot joint. Additionally, the agricultural implement includes a roll lock assembly alterable between a locked configuration and an unlocked configuration. The roll lock assembly includes a locking bar extending between a first end and a second end and coupled to the first frame member at a second pivot joint such that the locking bar is configured to rotate relative to the toolbar frame about the second pivot joint. Furthermore, the roll lock assembly includes a locking fastener configured to be selectively installed relative to the locking bar and the second frame member. Moreover, when the roll lock assembly is in the locked configuration, the locking fastener is inserted through both a portion of the second frame member and a portion of the locking bar to couple the locking bar to the second frame member in a manner that limits rotation of the first frame member and the second frame member relative to each other. Additionally, when the roll lock assembly is in the unlocked configuration, the locking bar is moveable relative to the portion of the second frame member with relative rotation between the first frame member and the second frame member.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates a perspective view of a portion of the agricultural implement shown in FIG. 1 with the row units removed, particularly illustrating various frame-related components of the implement along with one embodiment of a roll lock assembly suitable for use with the implement in accordance with aspects of the present subject matter;

FIG. 4 illustrates a zoomed-in, perspective view of the roll lock assembly and adjacent frame-related components shown in FIG. 3, particularly illustrating the roll lock assembly in a locked configuration;

FIG. 5 illustrates another zoomed-in, perspective view of the roll lock assembly and adjacent frame-related components shown in FIG. 3, particularly illustrating the roll lock assembly in an unlocked configuration; and

FIG. 6 illustrates a partially exploded perspective view of the roll lock assembly shown in FIG. 3, particularly illustrating the roll lock assembly disassembled from the adjacent frame-related components.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an agricultural implement. In one embodiment, the agricultural implement is configured as a strip tillage implement including a toolbar frame, a plurality of row units supported by the toolbar frame, and a plurality of ground-engaging tools supported by each row unit and configured to engage the field surface. Additionally, the strip tillage implement includes a hitch frame for coupling the strip tillage implement to a tow vehicle. The hitch frame is coupled to the toolbar frame, with the hitch frame and the toolbar frame being configured to rotate or pivot relative to each other as the strip tillage implement traverses the field.

Furthermore, in accordance with aspects of the present subject matter, the agricultural implement includes a roll lock assembly configured to be selectively locked and unlocked between the toolbar frame and the hitch frame to prevent or allow (depending on its locked or unlocked configuration) relative motion or pivoting between the frames. In one embodiment, the roll lock assembly may include a locking bar extending between a first and second end, with the locking bar being coupled to the toolbar frame at a pivot joint such that the locking bar is configured to rotate relative to the toolbar frame about the pivot joint. Additionally, the roll lock assembly may include a locking fastener, such as a pin, configured to be selectively installed between the locking bar and the hitch frame.

The roll lock assembly may be alterable between a locked configuration and an unlocked configuration. When the lock assembly is in the locked configuration, the locking fastener is inserted through both a portion of the hitch frame and a portion of the locking bar to couple the locking bar to the hitch frame in a manner that limits or prevent pivoting of the toolbar frame and the hitch frame relative to each other. Such a locked configuration is desirable, for example, when the implement is in its transport position and is being transported to or from the field (or between fields) to maintain a rigid, non-pivoting connection between the hitch frame and the toolbar frame. In contrast, when the roll lock assembly is in the unlocked configuration, the hitch frame and toolbar frame are allowed to pivot relative to each other, a configuration that is typically desirable during the performance of a strip tillage operation.

It should be appreciated that, although the roll lock assembly is generally described herein as being used in its locked configuration when the agricultural implement is being transported, the lock assembly may be used as more than a simple transport lock. For example, in certain instances, it may be desirable to provide a rigid, non-pivoting connection between the hitch frame and the toolbar frame during the performance of a strip tillage operation depending on the field conditions or desired output of the implement. It should also be appreciated that, although the present subject matter will generally be described herein with reference to a strip tillage implement, the disclosed lock assembly may generally be utilized in association with any suitable implement having any suitable implement configuration.

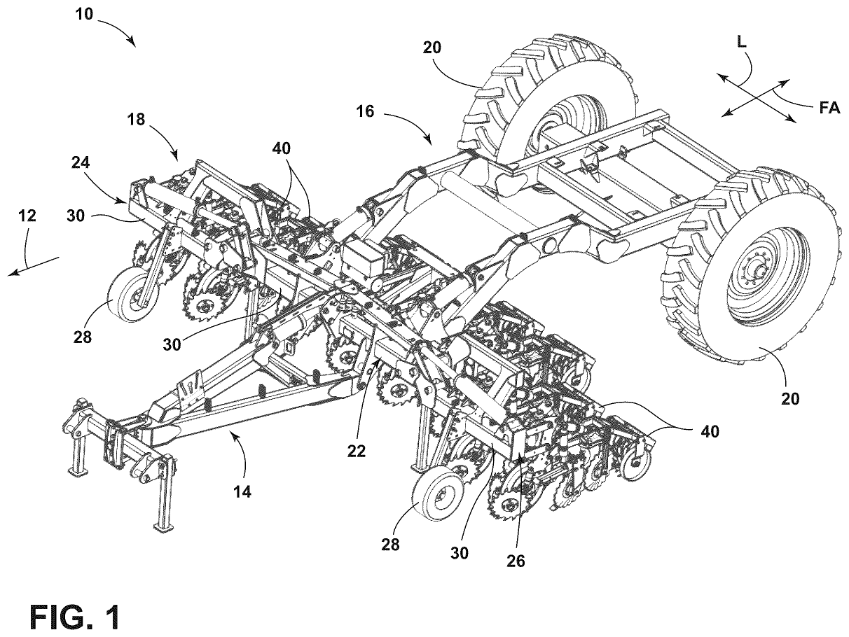

Referring now to the drawings, FIG. 1 illustrates a perspective view of one embodiment of an agricultural implement 10 in accordance with aspects of the present subject matter. In general, the implement 10 may be configured to be towed across a field in a forward direction of travel (e.g., as indicated by arrow 12 in FIG. 1) by a work vehicle (e.g., an agricultural tractor). As shown, the implement 10 is configured as a strip tillage implement. However, in other embodiments, the implement 10 may be configured as any other suitable type of implement, such as a seed-planting implement, a fertilizer-dispensing implement, and/or the like.

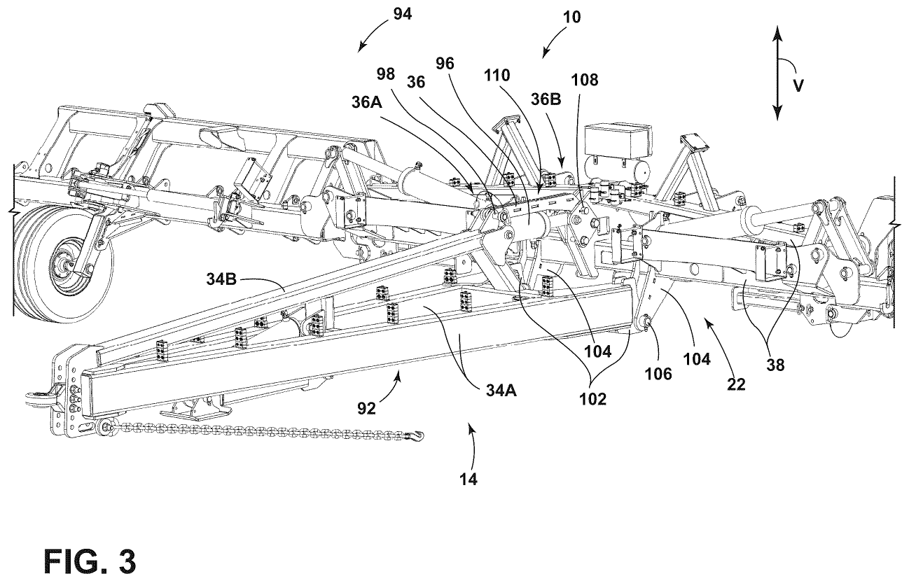

As shown in FIG. 1, the implement 10 includes a towbar assembly 14, a chassis assembly 16, and a toolbar assembly 18. As is generally understood, the towbar assembly 14 may be configured to allow the implement 10 to be coupled to a tow vehicle (e.g., a tractor) for towing the implement 10 along a field during the performance of a strip-tillage operation. For instance, the towbar assembly 14 may incorporate a hitch frame 92 (FIGS. 3-6) such as a three-point hitch frame, or other suitable hitch frame coupling for connecting the implement 10 to a tow vehicle. In one embodiment, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

It should be appreciated that, in the illustrated embodiment, the chassis assembly 16 is positioned at the aft end of the implement 10 such that the toolbar assembly 18 is disposed between the towbar assembly 14 and the chassis assembly 16 along the fore-aft direction of the implement 10 (as indicated by arrow FA in FIG. 1). For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the fore-aft direction FA of the implement 10 such that the toolbar assembly 18 is disposed at the aft end of the implement 10.

In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in the lateral direction L) from central toolbar section 22 (e.g., a first wing toolbar section 24 coupled to one lateral end of the central toolbar section 22 and a second wing toolbar section 26 coupled to the opposed lateral end of the central toolbar section 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may be configured to function as gauge wheels for the wing toolbar sections 24, 26.

As is generally understood, each of the various toolbar sections 22, 24, 26 may include one or more laterally extending toolbars 30 configured to support a plurality of row units 40. For instance, in one embodiment, each row unit 40 may be coupled to its respective toolbar 30 via a four-bar linkage. In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shanks or knives, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

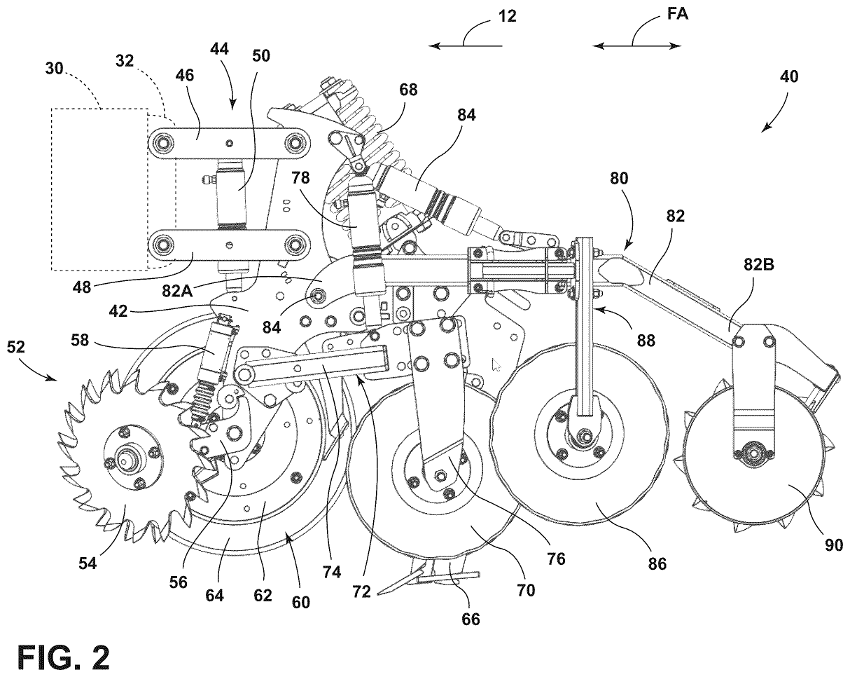

Referring now to FIG. 2, a side view of one embodiment of a row unit 40 suitable for use with the implement 10 shown in FIG. 1 is illustrated in accordance with aspects of the present subject matter. As shown, the row unit 40 includes a main frame or backbone 42 (referred to herein as simply the “frame 42” of the row unit 40) configured to be adjustably coupled to a toolbar (e.g., toolbar 30 and associated mounting bracket(s) 32) of the implement 10 via a linkage assembly 44. For example, in one embodiment, the frame 42 may be coupled to the toolbar 30 via a four-bar linkage including one or more pairs of first and second linkages 46, 48, with one end of each linkage 46, 48 being pivotably coupled to the frame 42 and the opposed end of each linkage 46, 48 being pivotably coupled to the toolbar 30 (e.g., via the associated mounting bracket(s) 32). However, it should be appreciated that, in alternative embodiments, the frame 42 of the row unit 40 may be coupled to the toolbar 30 in any other suitable manner. Additionally, the row unit 40 may include one or more downforce actuators 50 provided in operative association with the linkage assembly 44 for applying a downforce to the row unit 40. In one embodiment, the downforce actuators 50 may be passive actuators, such as air shocks or springs. Alternatively, the downforce actuators 50 may be actively controlled actuators, such as pneumatic or hydraulic cylinders.

Moreover, as shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (only one of which is shown in FIG. 2), with each disc 54 being pivotably coupled to the main frame via a respective row cleaner arm 56. As is generally understood, the row cleaner discs 54 may be toothed or spiked, such as by including a plurality of fingers or teeth extending radially outwardly from a central disc hub. As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 includes a pair of row cleaner actuators 58 (only one of which is shown in FIG. 2) configured to provide a downward biasing force against the row cleaner 52, with each row cleaner actuator 58 being coupled between the main frame 42 and a respective row cleaner arm 56. In one embodiment, the row cleaner actuators 58 may be passive actuators, such as air shocks or springs. Alternatively, the row cleaner actuators 58 may be actively controlled actuators, such as pneumatic or hydraulic cylinders.

Moreover, as shown in FIG. 2, the row unit 40 may also include a center coulter 60 positioned immediately aft of the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction L of the implement 10 (i.e., the direction into and out of the page in FIG. 2). In one embodiment, the center coulter 60 may include a central hub 62 coupled to the main frame 42 for rotation relative thereto and a peripheral blade 64 extending radially outwardly from the hub 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, in one embodiment, as the row cleaner discs 54 rotate relative to the ground, the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a centralized shank 66 mounted to the main frame 42 at a location aft of the central hub 62 relative to the forward direction of travel 12 of the implement 10. In one embodiment, the shank 66 may generally be aligned with the center coulter 60 along the longitudinal centerline of the row unit 40 (i.e., aligned with the center coulter 60 in the longitudinal direction of the implement 10). The shank 66 may be configured to break out the soil along the lateral width of the row being formed by the row unit 40 at a location aft of the center coulter 60. For example, the shank 66 may be aligned with the blade 64 of the center coulter 60 such that the shank 66 travels through and breaks open the slit or slot cut into the soil via the center coulter 60. As shown in FIG. 2, the row unit 40 may also include one or more shank actuators 68 provided in association with the shank 66 for providing a downward biasing force thereto. For instance, in the illustrated embodiment, the row unit 40 includes a pair of shank actuators 68, with each shank actuator 68 being coupled between the main frame 42 and the shank 66. In one embodiment, the shank actuators 68 may be passive actuators, such as air shocks or springs. Alternatively, the shank actuators 68 may be actively controlled actuators, such as pneumatic or hydraulic cylinders. In alternative embodiments, the shank 66 may be replaced with a different ground-engaging tool, such as centralized knife positioned immediately aft of the center coulter 60.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank 66 such that the discs 70 are spaced apart from the shank 66 in the lateral direction L of the implement 10. In one embodiment, each first side coulter disc 70 is pivotably coupled to the main frame 42 via a first side coulter mount assembly 72. For instance, as shown in FIG. 2, the side coulter arm assembly 72 includes a mounting arm 74 and a support arm 76, with the mounting arm 74 being pivotably coupled to the main frame 42 at one end and being coupled to the support arm 76 at the other end. The support arm 76 may, in turn, be coupled between the mounting arm 74 and its respective first side coulter disc 70 in a manner that allows the coulter disc 70 to rotate relative to the support arm 76 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the main frame 42 and a respective coulter arm assembly 72. In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the central shank 66 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth (e.g., 1-2 inches) to create scores or fracture lines” within the soil along the lateral edges of the row being formed. The shank 66 may, in turn, be configured to break out the hard soil across the lateral width extending between the fracture lines created by the side coulter discs 70.

Moreover, in several embodiments, the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the main frame 42 at a forward pivot point 44. Each frame member 82 extends rearwardly from the pivot point 44 relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank 66) relative to the forward direction of travel 12, with each second side coulter disc 86 being disposed along either side of the longitudinal centerline of the row unit 40 such that the discs 86 are spaced apart from the centerline in the lateral direction L of the implement 10. In one embodiment, the second side coulter discs 86 may be configured to catch or block the soil coming off of the first side coulter discs 70 and shank 66 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth (e.g., 1 inch or less) so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a second side coulter mount assembly 88. In one embodiment, the side coulter mount assembly 88 may be configured to allow the positioning of the second side coulter discs 86 to be adjusted relative to the other tools of the row unit 40, thereby allowing the coulter discs 86 to be set properly for performing their soil-catching function.

Moreover, as shown in FIG. 2, the row unit 40 may also include a finishing tool positioned at the aft end of the row unit 40. Specifically, in the illustrated embodiment, the row unit 40 includes a strip conditioner 90 coupled to the aft end 82B of the aft frame assembly 80. In general, the strip conditioner 90 may have any suitable configuration that allows it to perform its function as a finishing tool. In one embodiment, the strip conditioner 90 may be configured as a spider conditioner that functions to reduce the size of soil clods across the width of the row being formed. In other embodiments, a conditioning reel or basket may be used as the finishing tool.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration.

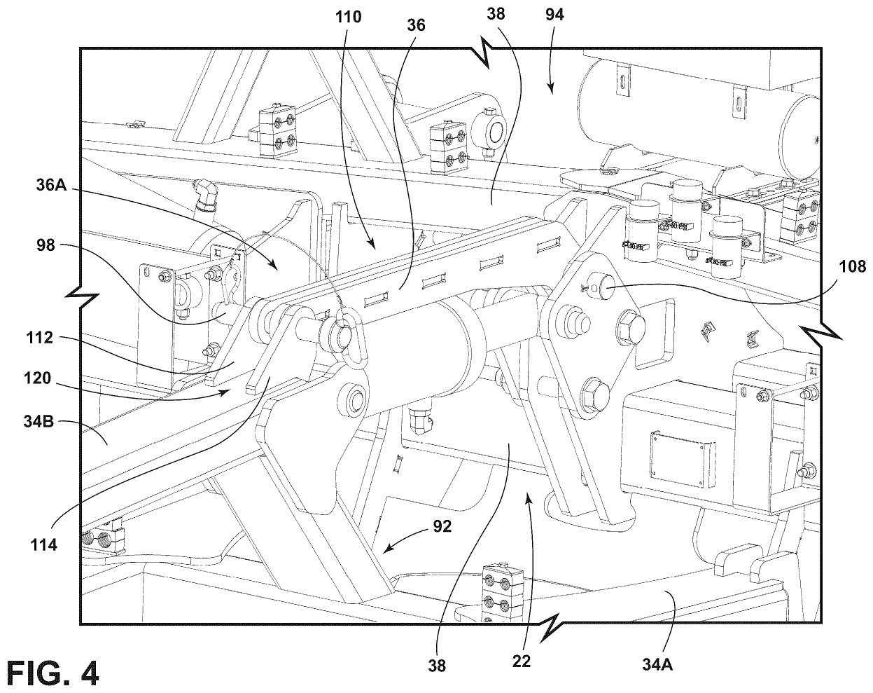

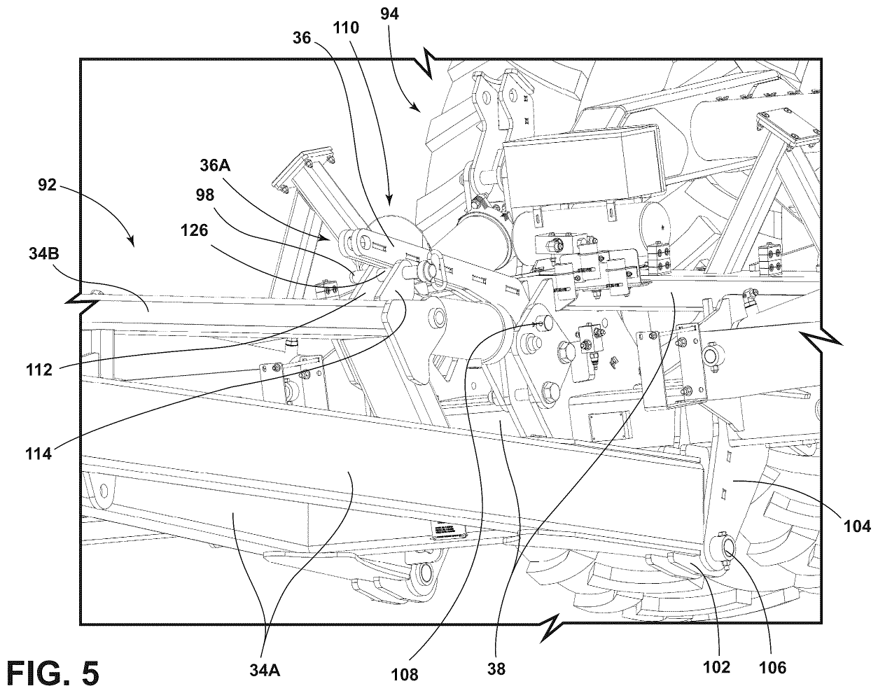

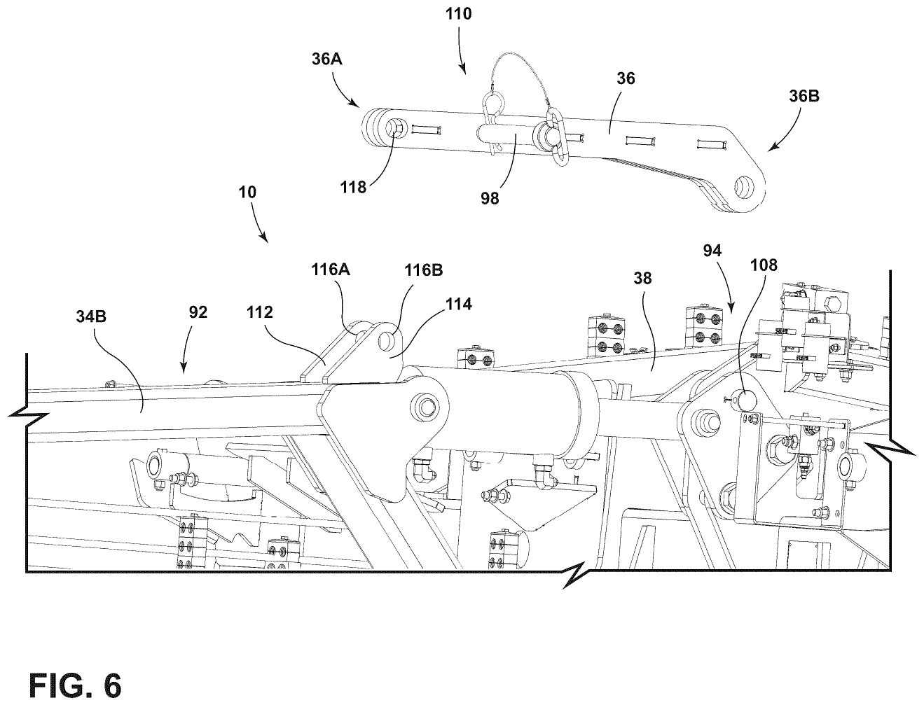

Referring now to FIGS. 3-6, differing perspective views of a portion of the agricultural implement 10 shown and described above with reference to FIG. 1 are illustrated in accordance with aspects of the present subject matter, particularly illustrating the row units 40 removed from the implement 10 for purposes of illustration. In particular, FIG. 3 illustrates various frame-related components of the implement 10, such as a hitch frame of the towbar assembly 14 and a toolbar frame of the central toolbar section 22, as well as a roll lock assembly 110 of the agricultural implement 10. Additionally, FIG. 4 illustrates a zoomed-in, perspective view of the roll lock assembly 110 and adjacent frame-related components shown in FIG. 3, particularly illustrating the roll lock assembly 110 in a locked configuration. Moreover, FIG. 5 illustrates another zoomed-in, perspective view of the roll lock assembly 110 and adjacent frame-related components shown in FIG. 3, particularly illustrating the roll lock assembly 110 in an unlocked configuration. Furthermore, FIG. 6 illustrates a partially exploded perspective view of the roll lock assembly 110, particularly illustrating the roll lock assembly disassembled from the adjacent frame-related components.

As shown in FIG. 3, the towbar assembly 14 is coupled to the central toolbar section 22 of the agricultural implement 10. In this respect, the towbar assembly 14 includes a plurality of towbar frame members 34 collectively defining a hitch frame 92 of the towbar assembly 14. For example, the towbar assembly 14 may include a pair of lower towbar frame members 34A and an upper towbar frame member 34B extending above the lower towbar members 34A along the vertical direction V. As such, the lower towbar members 34A and the upper towbar member 34B define the hitch frame 92. The pair of lower towbar frame members 34A of the hitch frame 92 each include a lower mounting bracket 102 for coupling the hitch frame 92 to the central toolbar section 22. Additionally, the central toolbar section 22 may include one or more central frame members 38 collectively defining a toolbar frame 94 of the central toolbar section 22. One of the central frame members 38 may include a pair of lower links 104, each lower link 104 being pivotably fastened (e.g., via one or more fastening pins) to one of the lower mounting brackets 102 of the lower towbar frame members 34A at a first pivot joint 106. As such, the hitch frame 92 is pivotably coupled to the toolbar frame 94 at the first pivot joint 106, thereby allowing the hitch frame 92 and the toolbar frame 94 to rotate or pivot relative to each other about the pivot joint 106 (e.g., in a roll direction of the implement 10).

Additionally, the agricultural implement 10 includes a roll lock assembly 110 configured to be selectively locked and unlocked between the hitch frame 92 and the toolbar frame 94 to selectively prevent or allow, as the case may be, relative pivoting between the frames 92, 94 about the pivot joint 106. In several embodiments, the roll lock assembly 110 includes a locking bar 36 extending between a first end 36A and a second end 36B, with the second end 36B of the locking bar 36 being coupled to the toolbar frame 94 at a second pivot joint 108. For example, the locking bar 36 may be fastened (e.g., via one or more fastening pins) to the toolbar frame 94 and configured to rotate relative to the toolbar frame 94 about the second pivot joint 108. Furthermore, the roll lock assembly 110 includes a locking fastener 98, such as a pin, configured to be selectively installed relative to the locking bar 36 and the hitch frame 92. The locking fastener 98 may be used to couple or decouple the first end 36A of the locking bar 36 to/from the hitch frame 92. As will be described below, by selectively coupling or decoupling the first end 36A of the locking bar 36 to the hitch frame 92, the roll lock assembly 110 may be alterable between a locked configuration in which relative pivoting between the toolbar frame 94 and the hitch frame 92 is limited or prevented, and an unlocked configuration in which relative pivoting between the toolbar frame 94 and the hitch frame 92 is permitted.

Furthermore, the agricultural implement 10 may also include an actuator 96 pivotably coupled between the toolbar frame 94 and the hitch frame 92. When the roll lock assembly 110 is in the unlocked configuration, actuation of the actuator 96 may result in pivoting of the hitch frame 92 and the toolbar frame 94 relative to each other in the roll direction. For instance, extension of the actuator 96 may result in relative pivoting between the frames 92, 94 in a first roll direction while retraction of the actuator 96 may result in relative pivoting between the frames 92, 94 in a second roll direction. In one embodiment, the actuator 96 may be configured as a fluid-filled actuator such as a hydraulic or pneumatic actuator. However, it should be appreciated that the actuator 96 may be configured as any suitable actuator configured to extend or retract resulting in rotation of the hitch frame 92 and the toolbar frame 94 relative to each other.

As mentioned previously, the roll lock assembly 110 may be alterable between a locked configuration as shown in FIG. 4, and an unlocked configuration as shown in FIG. 5. When the roll lock assembly 110 is in the locked configuration (FIG. 4), the locking bar 36 limits rotation of the toolbar frame 94 and the hitch frame 92 relative to each other. In this respect, the locking fastener 98 may be configured to be selectively installed relative to the locking bar 36 and the hitch frame 92. For example, the locking fastener 98 may fasten a portion of the locking bar 36, such as the first end 36A of the locking bar 36, to a portion of the hitch frame 92 in a manner that limits rotation of the toolbar frame 94 and the hitch frame 92 relative to each other. In this respect, the upper towbar member 34B may include a first bracket 112 and a second bracket 114 defining one or more bracket pin openings 116 (FIG. 6). For example, the first bracket 112 may define a first bracket pin opening 116A (FIG. 6) and a second bracket 114 may define a second bracket pin opening 116B (FIG. 6). Furthermore, the locking bar 36 may define one or more locking bar pin openings 118 (FIG. 6) that are configured to be aligned with the first and second bracket pin openings 116A, 116B (FIG. 6) when coupling the locking bar 36 to the hitch frame 92 via the fastener 98. Moreover, the first bracket 112 and the second bracket 114 may be spaced apart from one another such that a bar channel 120 is defined therebetween and configured to receive the locking bar 36, which may be insertable within the bar channel 120, to allow the locking fastener 98 (e.g., pin) to be inserted through both the first and second bracket pin openings 116A, 116B (FIG. 6) and the locking bar pin opening 118 (FIG. 6), thereby placing the lock assembly 110 in the locked configuration. As should be appreciated, in the locked configuration, the locking bar 36 of the roll lock assembly 110 generally provides a rigid connection between the hitch frame 92 and the toolbar frame 94, thereby limiting relative motion between such frames 92, 94.

To transition the roll lock assembly 110 from the locked configuration to the unlocked configuration, the locking fastener 98 may be removed from the aligned pin openings, 116A, 116B, 118, thereby decoupling the locking bar 36 from the hitch frame 92 and, thus, removing the rigid connection between the frames 92, 94. In such a decoupled or unlocked configuration, the hitch frame 92 and toolbar frame 94 may be configured to pivot or move relative to one another about the pivot joint 106 (e.g., via operation of the actuator 96).

As shown in FIG. 5, when the roll lock assembly 110 is in the unlocked configuration, the locking fastener 98 (e.g., pin) may, in one embodiment, be configured to provide a support surface about which the locking bar 36 (e.g., the first end 36A) is supported vertically relative to the hitch frame 92. In this respect, the locking fastener 98 (e.g., pin) may be configured to be inserted through the bracket pin openings 116 (FIG. 6) described above independent or separate from the locking bar 36. For example, as shown in FIG. 5, the locking fastener 98 (e.g., pin) is configured to be inserted through the first bracket pin opening 116A (FIG. 6) of the first bracket 112 and the second bracket pin opening 116B (FIG. 6) of the second bracket 114 without being inserted through the pin opening 118 of the locking bar 36. With such an installed state of the fastener 98 relative to the brackets 112, 114, in some embodiments, the locking bar 36 may lay atop an upper surface of the locking fastener 98.

Furthermore, when the roll lock assembly 110 is in the unlocked configuration, the position of the first end 36A of the locking bar 36 relative to the hitch frame 92 may generally vary as the locking bar 36 pivots (as indicated by arrow 122 in FIG. 3) about the second pivot joint 108 with relative rotation between the toolbar frame 94 and the hitch frame 92 (as indicated by arrow 124 in FIG. 3). In this respect, the locking bar 36 may be configured to slide along the support surface provided by the locking fastener 98 (e.g., pin) as the hitch frame 92 and the toolbar frame 94 rotate relative to each other. As such, a sliding interface 126 is defined between the locking fastener 98 (e.g., pin) and the locking bar 36.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A strip tillage implement, comprising:
a toolbar frame;
a plurality of row units supported by the toolbar frame;
a plurality of ground-engaging tools supported by each row unit of the plurality of row units and configured to engage a field surface;
a hitch frame configured to couple the strip tillage implement to a tow vehicle, the hitch frame coupled to the toolbar frame at a first pivot joint, the hitch frame and the toolbar frame configured to rotate relative to each other about the first pivot joint;
a roll lock assembly alterable between a locked configuration and an unlocked configuration, the roll lock assembly comprising:
a locking bar extending between a first end and a second end, the locking bar coupled to the toolbar frame at a second pivot joint such that the locking bar is configured to rotate relative to the toolbar frame about the second pivot joint; and
a locking fastener configured to be selectively installed relative to the locking bar and the hitch frame,
wherein, when the roll lock assembly is in the locked configuration, the locking fastener is inserted through both a portion of the hitch frame and a portion of the locking bar to couple the locking bar to the hitch frame in a manner that limits rotation of the toolbar frame and the hitch frame relative to each other, and
wherein, when the roll lock assembly is in the unlocked configuration, the locking bar is movable relative to the portion of the hitch frame with relative rotation between the toolbar frame and the hitch frame.

2. The strip tillage implement of claim 1, wherein the locking fastener comprises a pin configured to be inserted through one or more pin openings defined by the portion of the hitch frame and one or more corresponding pin openings defined by the portion of the locking bar to place the roll lock assembly in the locked configuration.

3. The strip tillage implement of claim 2, wherein the portion of the hitch frame comprises a first bracket defining a first pin opening of the one or more pin openings and a second bracket defining a second pin opening of the one or more pin openings, the first and second brackets being spaced apart from one another such that a bar channel is defined therebetween that is configured to receive the portion of the locking bar, the portion of the locking bar being insertable within the bar channel to allow the pin to be inserted through the first and second pin openings defined by the first and second brackets and the one or more corresponding pin openings defined by the portion of the locking bar to place the roll lock assembly in the locking configuration.

4. The strip tillage implement of claim 3, wherein, when the roll lock assembly is in the unlocked configuration, the pin is configured to be inserted through the first and second pin openings to provide a support surface about which the locking bar is supported vertically relative to the first and second brackets as the hitch frame and the toolbar frame rotate relative to each other.

5. The strip tillage implement of claim 4, wherein a sliding interface is defined between the pin and the locking bar when the roll lock assembly is in the unlocked configuration such that the locking bar slides across the support surface of the pin as the hitch frame and the toolbar frame rotate relative to each other.

6. The strip tillage implement of claim 1, wherein, when the roll lock assembly is in the unlocked configuration, the locking fastener is configured to vertically support the locking bar relative to the portion of the hitch frame for movement relative thereto.

7. The strip tillage implement of claim 6, wherein the locking fastener comprises a pin configured to be inserted through one or more pin openings defined by the portion of the hitch frame and one or more corresponding pin openings defined by the portion of the locking bar to place the roll lock assembly in the locked configuration, wherein, when the roll lock assembly is in the unlocked configuration, the pin is configured to be inserted through the one or more pin openings to provide a support surface about which the locking bar is supported vertically relative to the portion of the hitch frame as the hitch frame and the toolbar frame rotate relative to each other.

8. The strip tillage implement of claim 1, further comprising:
an actuator pivotably coupled between the toolbar frame and the hitch frame,
wherein, when the roll lock assembly is in the unlocked configuration, extension or retraction of the actuator results in rotation of the hitch frame and the toolbar frame relative to each other.

9. An agricultural implement, comprising:
a first frame member;
a second frame member coupled to the first frame member at a first pivot joint, the second frame member and the first frame member configured to rotate relative to each other about the first pivot joint;
a roll lock assembly alterable between a locked configuration and an unlocked configuration, the roll lock assembly comprising:
a locking bar extending between a first end and a second end, the locking bar coupled to the first frame member at a second pivot joint such that the locking bar is configured to rotate relative to the toolbar frame about the second pivot joint; and
a locking fastener configured to be selectively installed relative to the locking bar and the second frame member,
wherein, when the roll lock assembly is in the locked configuration, the locking fastener is inserted through both a portion of the second frame member and a portion of the locking bar to couple the locking bar to the second frame member in a manner that limits rotation of the first frame member and the second frame member relative to each other, and
wherein, when the roll lock assembly is in the unlocked configuration, the locking bar is moveable relative to the portion of the second frame member with relative rotation between the first frame member and the second frame member.

10. The agricultural implement of claim 9, wherein the locking fastener comprises a pin configured to be inserted through one or more pin openings defined by the portion of the second frame member and one or more corresponding pin openings defined by the portion of the locking bar to place the roll lock assembly in the locked configuration.

11. The agricultural implement of claim 10, wherein the portion of the second frame member comprises a first bracket defining a first pin opening of the one or more pin openings and a second bracket defining a second pin opening of the one or more pin openings, the first and second brackets being spaced apart from one another such that a bar channel is defined therebetween that is configured to receive the portion of the locking bar, the portion of the locking bar being insertable within the bar channel to allow the pin to be inserted through the first and second pin openings defined by the first and second brackets and the one or more corresponding pin openings defined by the portion of the locking bar to place the roll lock assembly in the locking configuration.

12. The agricultural implement of claim 11, wherein, when the roll lock assembly is in the unlocked configuration, the pin is configured to be inserted through the first and second pin openings to provide a support surface about which the locking bar is supported vertically relative to the first and second brackets as the second frame member and the first frame member rotate relative to each other.

13. The agricultural implement of claim 12, wherein a sliding interface is defined between the pin and the locking bar when the roll lock assembly is in the unlocked configuration such that the locking bar slides across the support surface of the pin as the second frame member and the first frame member rotate relative to each other.

14. The agricultural implement of claim 9, wherein, when the roll lock assembly is in the unlocked configuration, the locking fastener is configured to vertically support the locking bar relative to the portion of the second frame member for movement relative thereto.

15. The agricultural implement of claim 14, wherein the locking fastener comprises a pin configured to be inserted through one or more pin openings defined by the portion of the second frame member and one or more corresponding pin openings defined by the portion of the locking bar to place the roll lock assembly in the locked configuration, wherein, when the locking bar is in the unlocked configuration, the pin is configured to be inserted through the one or more pin openings to provide a support surface about which the locking bar is supported vertically relative to the portion of the second frame member as the second frame member and the first frame member rotate relative to each other.

16. The agricultural implement of claim 9, further comprising:
an actuator pivotably coupled between the toolbar frame and the hitch frame,
wherein, when the roll lock assembly is in the unlocked configuration, extension or retraction of the actuator results in rotation of the hitch frame and the toolbar frame relative to each other.

17. The agricultural implement of claim 9, wherein the first frame member comprises a toolbar frame supporting a plurality of ground-engaging tools configured to engage a field and the second frame member comprises a hitch frame configured to couple the agricultural implement to a tow vehicle.
